(19) United States
(12) Patent Application Publication
(10) Pub. No.: US 2009/0201380 A1
(43) Pub. Date: Aug. 13, 2009

(54) METHOD AND APPARATUS FOR STREAMLINED WIRELESS DATA TRANSFER

(75) Inventors: Ronald L Peaslee, Huntsville, AL (US); James Mahaffey, Hazel Green, AL (US)

Correspondence Address: Emerson, Thomson & Bennett, LLC, 777 W. Market Street, Akron, OH, 44303, US

(73) Assignee: DECISIVE ANALYTICS CORPORATION, Arlington, VA (US)

(21) Appl. No.: 12/261,174

(22) Filed: Oct. 30, 2008

Related U.S. Application Data
(60) Provisional application No. 61/027,973, filed on Feb. 12, 2008.

(51) Int. Cl. H04N 5/228

(52) U.S. Cl. 348/208.4; 348/E05.031

(57) ABSTRACT

An apparatus having at least a first interface system. The at least a first interface system has a sensor interface portion for receiving an input of successive frames of a moving image from a video capture device; a processor portion that causes the input of successive frames of the moving image to be stabilized, compressed, and averaged, and a transmission component portion for transmitting the stabilized, compressed, and averaged input of successive frames of a moving image across a network. The stabilization of the successive frames of the moving image reduces the effects of unintended motion of the video capture device and is utilized to determine a feedback control. The processor portion utilizes the feedback control to cause the moving image to remain substantially centered within the individual frames of the input of successive frames of the moving image by causing the adjustment of the video capture device.

### I. BACKGROUND

This application claims priority to a provisional patent application, Ser. No. 61/027,973, filed Feb. 12, 2008, entitled, Method and Apparatus For Streamlined Wireless Data Transfer, the entirety of which is hereby incorporated by reference. This invention pertains to the art of methods and apparatuses regarding a communications interface system and more specifically to apparatuses and methods regarding a communications interface system for reducing the bandwidth required to transmit streaming video across a network.

### II. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 shows a block diagram view of the invention, according to one embodiment;

FIG. 2 shows a diagram of a sensor device, camera, and scanner;

FIG. 3A shows an image frame and the motion of vectors;

FIG. 3B shows an image frame and the motion of vectors;

FIG. 4 shows a diagram of a CPU;

FIG. 5 shows a diagram of the stabilization and compression;

FIG. 6 shows a diagram of ground sensors;

FIG. 7 shows a diagram of remote valve monitoring;

FIG. 8 shows a diagram of fire line monitors;

FIG. 9 shows wireless sensor nodes;

FIG. 10 shows a diagram of RF engine networks;

FIG. 11 shows a flow chart of display logic;

FIG. 12 shows a diagram of various embodiments of the invention;

FIG. 13 shows various embodiments of the invention;

FIG. 14 shows various embodiments of the invention;

FIG. 15 shows environmental sensors;

FIG. 16 shows a man tracker embodiment;

FIG. 17 shows a UV spectrometer embodiment;

FIG. 18 shows an optical laser ranger;

FIG. 19 shows an explosive detection embodiment;

FIG. 20 shows a weapon watch embodiment;

FIG. 21 shows a diagram of a drop repeater;

FIG. 22 shows a flow chart of an embodiment of the invention; and,

FIG. 23 shows a flow chart of an embodiment of the invention.

### III. DEFINITIONS

The following terms may be used throughout the descriptions presented herein and should generally be given the following meaning unless contradicted or elaborated upon by other descriptions set forth herein.

“Asynchronous transfer mode” or “ATM” means a network technology based on transferring data in fixed size packets across a fixed or dedicated channel established upon initiating the transfer of data.

“Averaging” or “quantization” means a process during the compression of video image data that attempts to determine what information can be safely discarded without a significant loss in visual fidelity.

“B-frame” or “bi-directional frame” or “bi-directional predicted frame” means an individual frame within a motion sequence grouped and played back so that the viewer registers the video's spatial motion that contains only the data that has changed from the preceding frame or is different from the data in the next successive individual frame.

“Circuit switching network” means a protocol in which a dedicated line is allocated for transmission between two parties or components.

“Cluster” a group of one or more sectors.

“Compression” means converting data to a format that requires less space than the original format.

“Format” means a specific pre-established arrangement or organization of data.

“Frame” means a set of corresponding to a single point in time.

“I-frame” or “key-frame” means an 8×8 block of non-overlapping pixels. Short for intraframe, a video compression method used by the MPEG standard. In a motion sequence, individual frames of pictures are grouped together (called a group of pictures, or GOP) and played back so that the viewer registers the video's spatial motion. An I-frame is a single frame of digital content that the compressor examines independent of the frames that precede and follow it and stores all of the data needed to display that frame. Typically, I-frames are interspersed with P-frames and B-frames in a compressed video. The more I-frames that are contained, the better quality the video will be; however, I-frames contain the most amount of bits and therefore take up more space on the storage medium.

“Image” or “digital image” means a digital representation of an optically formed duplicate or other reproduction of an object formed by a lens or a mirror.

“Intra-frame compression” means using only the current frame to compress the current frame.

“Inter-frame compression” means using one or more previous or subsequent frames in a sequence of successive frames to compress the current frame.

“Interface” means a device across which two independent systems meet and act on or communicate with each other. A user interface, such as a keyboard or mouse, allows the user to communicate with the operating system. A software interface, such as computer languages and codes used by an application, allow that application to communicate with other applications and with the associated hardware. A hardware interface, such as wires, plugs, and sockets, allow two or more hardware devices to communicate with each other.

“Macroblock” means four I-frames arranged into a bigger 16×16 block of non-overlapping pixels.

“P-frame” or “predictive frame” or “predicted frame” means an individual frame within a motion sequence grouped and played back so that the viewer registers the video's spatial motion that follows an I-frame and contains only the data that has changed from the preceding I-frame.

“Packet” means a portion or piece of a message transmitted over a packet-switching network. A packet contains its destination address in addition to the data that comprises the message.

“Packet-switching network” means a protocol in which messages are divided into packets before they are transmitted over a network. Each packet is then transmitted individually and can follow different routes to the destination address. Upon receipt of all of the packets forming a message, the packets are recompiled into the original message.

“Pixel” or “picture element” means a single point in a graphic image.

“Power supply” means the component that pulls the required amount of electricity from a source and converts the AC current to DC current. The power supply also regulates the voltage to eliminate spikes and surges common in most electrical systems.

“Repeater” means a device that receives a digital signal on an electromagnetic or optical transmission medium and regenerates the digital signal along a second portion or leg of the transmission medium.

“Sector” means a physical unit on a storage media capable of storing a certain amount of information. The geometry of the storage media includes a number of cylinders, tracks per cylinder, and sectors per track.

“Sensor” means a detecting device.

“Spatial redundancy” means non-changing pixels within a specific frame.

“Stabilizing” means processing image data to eliminate motion induced flicker in a displayed image. The motion induced flicker may result from movement of the image during image capture, movement of the image capture device during image capture, or both.

“Temporal redundancy” means non-changing pixels between two frames.

### IV. DETAILED DESCRIPTION

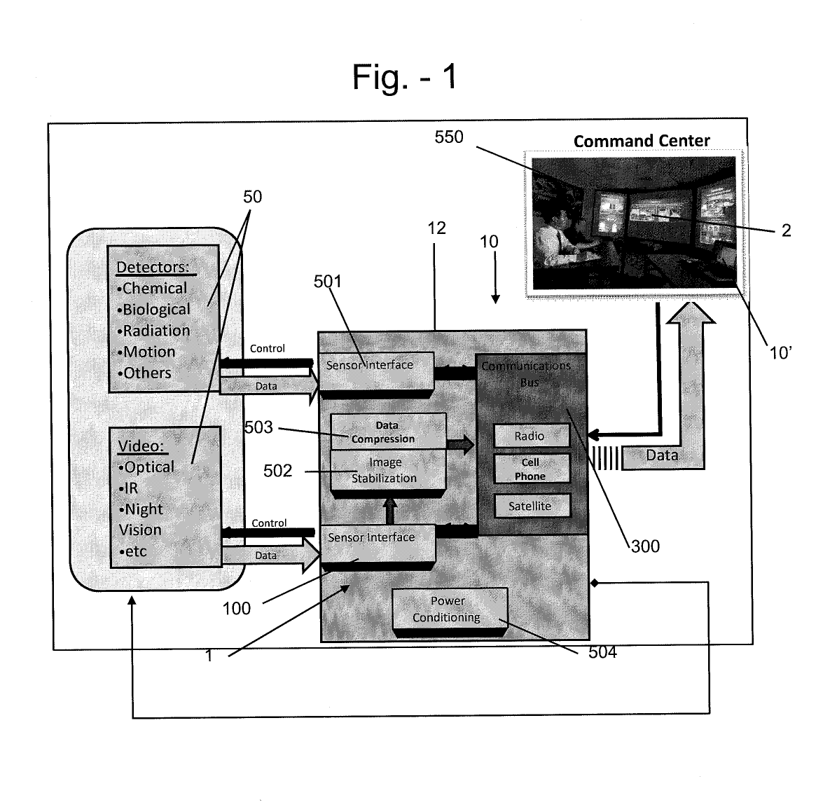

Referring now to the drawings wherein the showings are for purposes of illustrating embodiments of the invention only and not for purposes of limiting the same, FIG. 1 shows a decisive interface box system 10 according to one embodiment of the invention. In one embodiment, the decisive interface box system 10 comprises a computer 1 enclosed in a hardened exterior shell 12. In one embodiment, the hardened exterior shell 12 comprises a lightweight, water resistant temperature controlled environmental container. The decisive interface box system 10 interfaces with at least a first sensor device 50 to transmit captured image data, or digital video, collected or photographed by the first sensor device 50, wherein the captured image data represents an image to be displayed on a display device 2. The interface box system 10 comprises a sensor interface portion 100, and an image processing portion, a sensor interface 501, an image stabilization portion 502, a data compression portion 503, a power conditioning portion 504, and a communications bus 300.

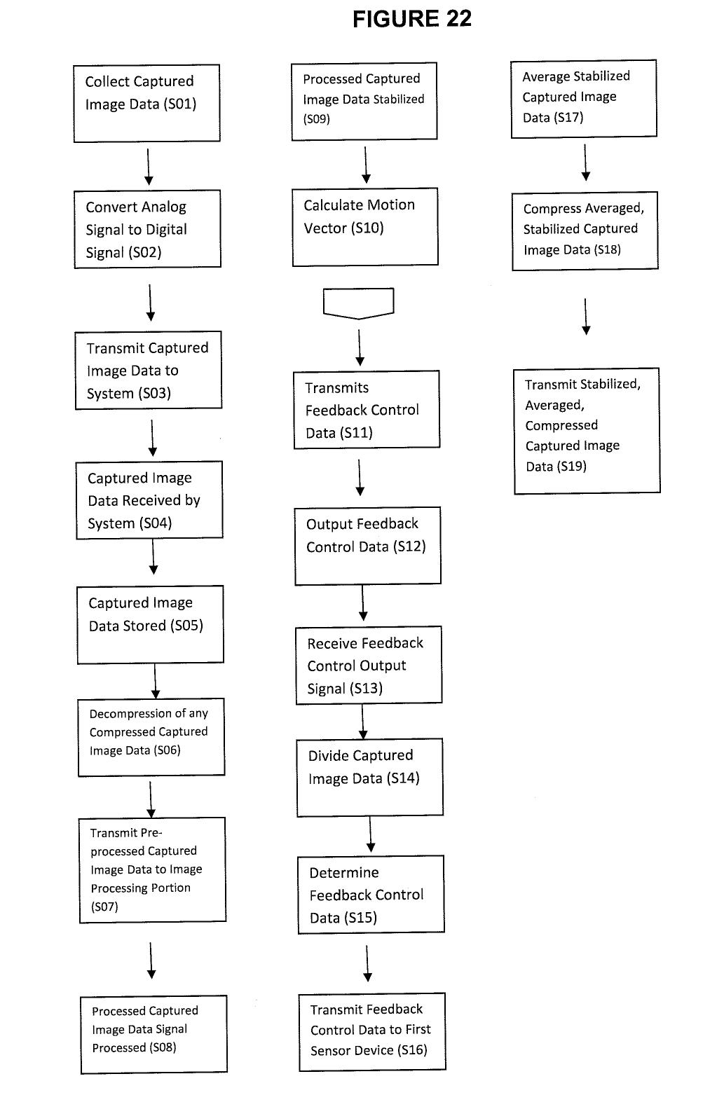

With reference now to FIGS. 1 and 22, in one embodiment, the sensor interface portion 100 comprises a 1×4 video distribution amplifier to provide an analog video signal to each of the four video channels. Each channel contains an image input unit for receiving the captured image data transmitted from the image capture device and a pre-processing unit for processing the captured image data before it is transmitted. The image capture device transmits the captured image data to the image input unit (step S05). The pre-processing unit decompresses any compressed captured image data received from the image capture device (step S06). The pre-processing unit then transmits the pre-processed captured image data to the image processing portion (step S07). It is to be understood that the image capture device can be any device capable of capturing an image.

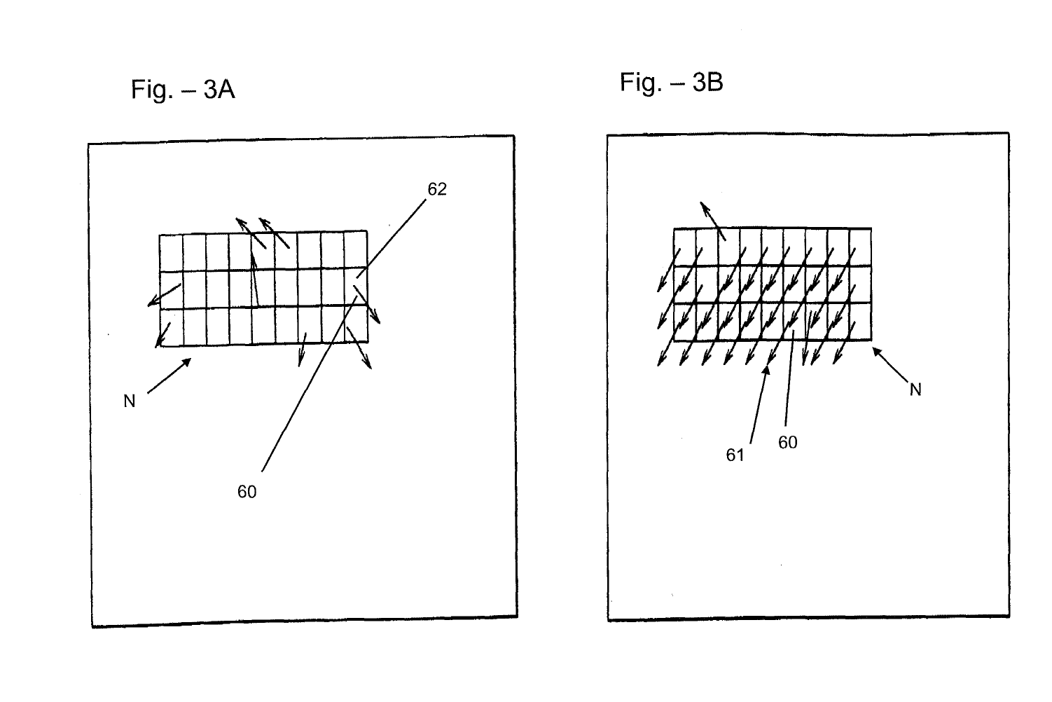

With reference now to FIGS. 1, 3A, and 3B, the image processing portion comprises an image stabilization unit, an image compression and averaging unit, and an image encoding unit. The image stabilization portion 502 performs processing of the captured image data (step S08) by performing signal processing on the raw captured image data to remove and prevent noise from the input images. The image stabilization portion 502 then stabilizes the captured image data (step S09) to eliminate motion induced flicker in the displayed image. The image stabilization portion 502 determines a motion vector of a macro block (step S10) by comparing individual stabilized images with the preceding stabilized images. For example, the image stabilization unit calculates the motion vector based on differences between the captured image data of a first image frame N and the captured image data of at least a first preceding image frame N−1 of the captured image data. The motion vector indicates a direction of a tracked image moving among the captured image data of the preceding and following frames. The motion vector is represented in two dimensions, i.e., in the horizontal and vertical directions. For example, if the motion vector of a particular macro block shows the values (2,−3), it means the motion vector of the particular macro block has moved by two pixels in the horizontal direction, and by −3 pixels in the vertical direction.

The image stabilization portion 502 utilizes the motion vector to determine a feedback control data (step S10). The image stabilization portion 502 transmits the feedback control data to the image capture device control portion (step S11). The image capture device control portion then causes the sensor interface portion 100 to output the feedback control data, in the form of a feedback control output signal, to the image capture device (step S12). The image capture device receives the feedback control output signal (step S13). The feedback control output signal causes the adjustment of the image capture device wherein the tracked image is “tracked” or maintained substantially centered within the individual frames of the captured image data. In one embodiment, a driving unit of the image capture device receives the feed control signal. The driving unit drives the image capture device according to the control feedback output signal from the image capture device control unit. Accordingly, the drive unit includes a lens driving unit for adjusting the lens for pan/tilt and zoom-in/zoom-out with respect to the input tracked image, and an image capture device driving unit for shifting the direction of the image capture device and to track and photograph the tracked image. Video stabilization is used to remove or minimize effects of camera movement or to compensate for the inability to maintain accurate camera tracking on moving subjects. Intergraph™ VASRT components include two different DirectShow filters that implement different stabilization algorithms. The choice of the appropriate stabilization filter depends on the characteristics of the source video and the intended use of the stabilized output. In most cases, in addition to providing a video stream with increased clarity, stabilization can increase the compression ratio of the stream by reducing the overall inter-frame changes that must be encoded in the compressed stream. The first filter determines overall motion within the video frame sequence by tracking shifts of sub-sampled areas of each frame. This uses a technique similar to the analysis performed in MPEG compression, where each frame is sub-divided into smaller regions and then each region is transformed from a spatial representation to a frequency representation using signal analysis algorithms. This has the effect of creating a compressed and simplified signature of each sub-region. Then, the signatures of the regions are compared on a frame-by-frame basis. Similar and corresponding sub-regions are then categorized by shifts in the horizontal and/or vertical directions. Sub-regions with signatures that change considerably are not considered in calculating movement.

In MPEG compression, the position deltas for each sub-region are used to reduce the amount of information needed to store or transmit the video stream. In the Stabilize filter, the deltas of each sub-region are integrated to determine if large areas of the image show a statistically significant correlated shift. If they do, then the output frame is shifted in the horizontal and/or vertical direction by applying an inverse of the overall frame delta. This has the effect of minimizing or eliminating the movement of the each frame in the sequence. Parameters to the filter are used to determine the area of the image that will be examined and to specify the maximum delta that can be applied to each frame. For example, if the camera is panning, a sequence of frames will show a progressively increasing shift counter to the direction of the pan. When the delta reaches the maximum, the next frame will “re-center” and the process will continue. As each frame shifts, the outer region that is exposed by the Stabilization shift will either be filled with all black pixels or the extreme edge of pixels from the original frame image will be duplicated. The quality of the stabilization also depend on whether the camera motion is slow enough that it doesn't cause motion blurring effects within individual frames. For example, to eliminate higher frequency vibration, a digital camera with a fast sensor (akin to a higher shutter speed in a film or still camera) will be required for optimal results. The second stabilization filter is designed to stabilize video where the object or area of interest consists of a high contrast, well defined area within each frame. For example, a plane filmed against the sky, a vehicle moving in front of a contrasting background, or relatively hot or cold areas in an infrared video. The second filter expands the dynamic range of each frame's image and mathematically determines the centroid of the overall brightest or darkest contiguous regions of the frame by statistical averaging. The frame is then shifted in the video field by horizontal and vertical deltas calculated from the differences between the coordinates of the center of each frame and the coordinates of the centroid.

Averaging is also done between successive frames to minimize errors created by transient elements within the frame, such as clouds or foreground objects as the camera is panned. In general, the maximum deltas for the second filter are greater than for the first filter since the object of interest is typically more important than the rest of the frame's background. Stabilization using the second filter is typically better than first filter when the source video meets the criteria of having an object of interest that is contained within a subset of the frame, the object or area of interest has a high contrast or difference in brightness from the rest of the frame, and the background of the frame is relatively simple. The software using the averaging filter is useful for minimizing atmospheric disturbances, such as heat waves, smoke, or fog; bringing out details in grainy or low-resolution source video; and for eliminating pixel “noise” introduced in the source video by light amplification or by algorithmically increasing the gain on the frame images. The average filter works by blending a number of frames together. In effect, it “stacks” a number of frames of top of each other. The number of frames to average is specified by a parameter to the filter. The pixel values for each frame to be averaged are divided by a factor determined by the number of frames. This prevents the resulting averaged frame from being “washed out” or excessively brightened. Since each of the frames that are to be averaged together need to be accurately registered, it is important that the camera be stationary. If the subject is in motion or the camera is panning or zooming, the average filter will produce a blurring effect. The strength of the blurring depends on the number of frames being averaged. The effect is barely noticeable when using two frames at a time, but become pronounced at four or more frames. Since pixel noise and atmospheric effects tend to be transient, where each pixel is affected for no more than one or two frames at a time, use of the average filter can almost completely eliminate these effects from the resulting video. For low contrast, grainy, and/or low resolution source video, the average filter will accentuate “real” features of the original scene while de-accentuating transient defects. This effect can bring out finer detail than is present in any of the individual source frames. Because intra-frame stability is important for effective application of this filter, passing the video through either of the stabilization filters prior to averaging will increase the quality of the averaged video.

The image compression unit performs data compression in order to reduce the volume of data transmitted from the image capture device, and outputs the compressed data to a storage device or to the transmission component. The image compression unit comprises a post-processing unit for post-processing of the captured image data in relation to the compression of the captured image data for which the motion vector is calculated.

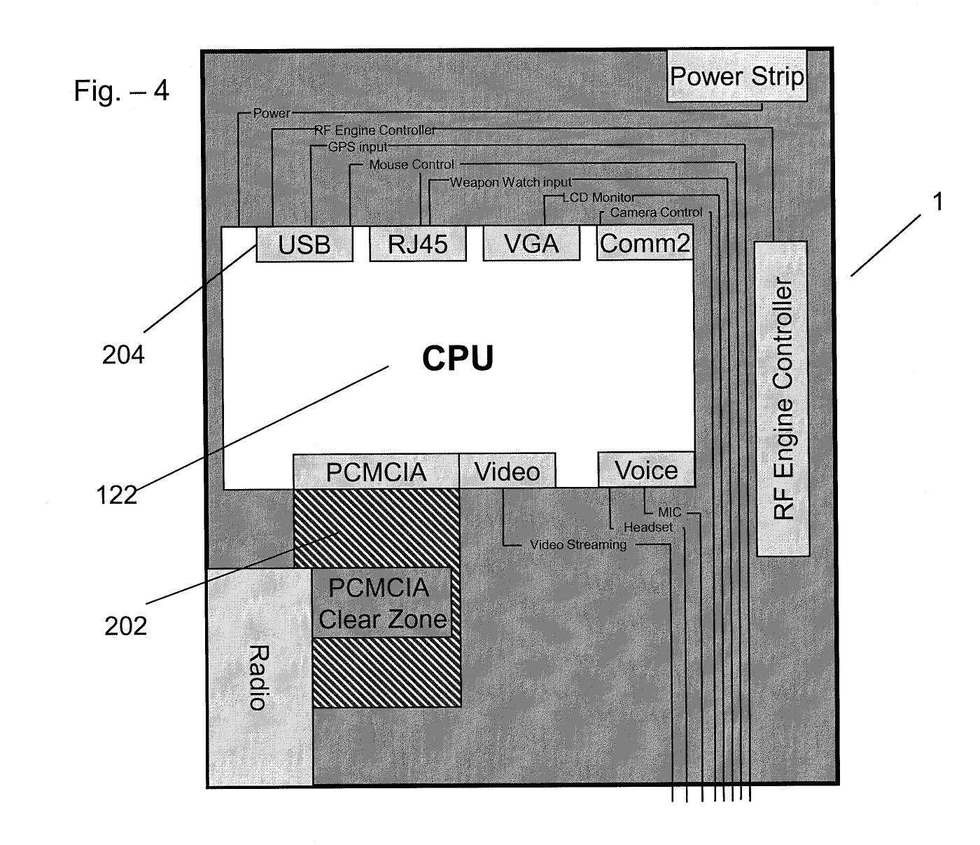

With reference now to FIG. 4, in one embodiment, the computer 200 comprises a memory portion 202, a mass storage device 204, a first input device 206, a first output device 208, and a central processing unit (CPU) 122. The memory portion 202 enables the computer 200 to store, at least temporarily, data and programs. In one embodiment, the memory portion 202 comprises random access memory, read only memory. The mass storage device 204 allows the computer 200 to permanently retain large amounts of data. In one embodiment, the mass storage device 204 may comprise an optical computer-readable medium such as a CD or DVD. The input device 206 is the conduit through which data and instructions enter the computer 200. In one embodiment, the input device 206 comprises a keyboard. In another embodiment, the input device 206 comprises a mouse. The output device 208 allows the operator to view an output caused by inputted data and instructions. In one embodiment, the output device 208 comprises a display screen. In another embodiment, the output device 208 comprises a printer. The CPU 122 executes the instructions inputted to the computer 200.

With reference now to FIG. 4, in one embodiment, the processor portion 120 comprises a central processing unit (CPU) 122, a memory portion 124, and a first bus component 126. The CPU 122 can be implemented as a microcontroller, a microprocessor, or a microcomputer. The memory portion 124 comprises a dynamic main memory 126, a fast cache memory 128, and a non-volatile random access memory (NVRAM) 130. Optionally, the memory portion 124 may also comprise one or more magnetic storage devices for storing executable software necessary for the operation of the interface box system 10 and its associated components. The memory portion 124 is in communication with the CPU 122 via the first bus component 126. The first bus component 126 additionally allows for the CPU 122 to be in communication with the interface portion 100 and the transmission portion 140.

With reference now to FIG. 4, the computer 200 comprises a programmable machine that responds to a specific set of instructions and can execute a program or prerecorded list of instructions. In one embodiment, the mass storage device portion 204 may comprise a disc drive. In another case, the mass storage device portion 204 may comprise a tape drive. The input device portion comprises a means for entering data and instructions into the computer. In one embodiment, the input device portion comprises a keyboard and a mouse. The output device portion comprises a means for allowing the operator to view results achieved by the computer through executing inputted instructions or data. The output device portion may comprise a display device, a sound speaker, and a printer. The CPU causes the execution of the instructions inputted into the computer. Additionally, the CPU may at least partially control the operation of the various components comprising the computer. The CPU comprises a sensor interface portion 100, an image processing portion 120, and a transmission portion 140. The power supply supplies power to the computer. The power supply may comprise a lithium battery component or may comprise a solar power component. The decisive interface box system 10 comes in one of two configurations (mobile or movable). A movable configuration can be fixed to a pole, wall, or any other hard point and then moved to a different fixed, hard point in a matter of minutes. This configuration is normally connected to 115 VAC (wall outlet) and the power is converted at the source to the required 12 VDC used for operations. The mobile system is entirely different, since it is working on a vehicle all of the power for the interface box system 10, extending masts, displays and communications backbone has to be generated by the vehicle. The auxiliary gel batteries are designed to power the electronics environment of the vehicles. The sensors are powered by solar cells when they are deployed in the field with the exception of the Man Tracker™ (GPS device used to locate either first responders or injured people in a disaster). The Man Tracker™ is charged from a 115 VAC outlet and has an estimated powered life of 12 hours. In some cases the solar cell turns the sensors on to a passive (listen only) state to save power while they are in the field. The sensors are never really off; they are placed in a low power state where they only listen for other sensor traffic on the mesh network. Should another sensor become active with transmissions from the active sensor the rest of the mesh network goes active allowing data to reach the interface box system 10. After a few minutes with an active mesh the sensors shut down to a passive state and the solar cells continue to power the batteries. If the sensor enters into a very active state, the onboard batteries will keep the sensor working for three days without being charged. After 3 days, the system will shut down for recharging. Because of this charging logic, the sensors can remain in the field for as long as their rechargeable batteries continue holding a charge (1 to 2 years) without any support from a human operator. In one embodiment, the system 10 is in a temperature controlled container, contains line replaceable components, is lightweight, water resistant, shock mounted, remotely updateable software, with multiple communications capability.

The sensor interface portion 100 comprises a plurality of driver interfaces and allows for the control of at least the first sensor device 50. In one embodiment, the sensor interface portion 100 comprises a universal serial bus (USB) connection 102, a RJ45 connection 104, a video graphics adapter (VGA) connection 106, a COMM2 connection 108. The sensor interface portion 100 may comprise any number and type of driver interfaces chosen with sound judgment by a person of ordinary skill in the art. In one embodiment, the sensor interface portion 100 further comprises an image input unit for receiving the captured image data transmitted from the first sensor device 50 and a pre-processing unit for initially processing the captured image data.

With reference now to FIGS. 1 and 22, in one embodiment, the captured image data is collected by the at least a first sensor device 50 (step S01) and then converted from an analog signal to a digital signal (step S02) by the at least a first sensor device 50 as is well known in the art. The analog-to-digital conversion process results in the creation of a set of numbers representing the shape and various attributes of the captured image, that is, the captured image data. The at least a first sensor device 50 transmits the digital signal or captured image data to the decisive interface box system 10 (step S03). The at least a first sensor device 50 may transmit the captured image data to the decisive interface box system 10 utilizing any transmission medium, such as coaxial cable, fiber optic cable, or wireless communication mediums chosen with sound judgment by a person of ordinary skill in the art. In one embodiment, the at least a first sensor device 50 first compresses the captured image data prior to transmitting the captured image data to the decisive interface box system 10.

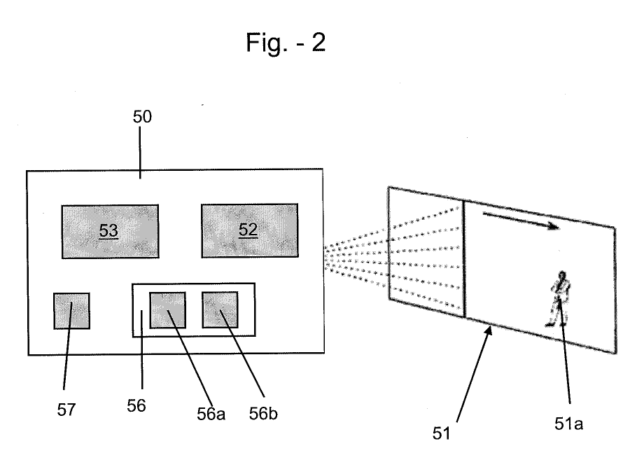

With reference now to FIG. 2, in one embodiment, the at least a first sensor device 50 comprises a line-scan camera 52 and a scanner 53 and views a monitored region 51. The at least a first sensor device 50 produces an electronic video signal corresponding to the light intensity profile along a single axis or a single line in space. The line-scan camera 52 operates by using a lens to focus light from the line in space being viewed onto a linear array sensor, such as a charge coupled device (CCD). During each line sampling period, typically lasting 10 to 500 microseconds, light being reflected or otherwise emitted from a narrow vertical line in the monitored region is captured by the line-scan camera 52, which generates a corresponding electronic video signal. On each line readout, the electronic video signal is composed of a temporal sequence of analog voltage levels, with each voltage level being proportional to the light detected by one of the 1024 to 8192 sensor elements. In this manner, the viewed line in the monitored region can be converted into an electronic signal in a period of 10 to 500 microseconds with a resolution of 1024 to 8192 pixels.

With continued reference now to FIG. 2, in one embodiment, the scanner 53 is a mechanism that sweeps the viewed line in the horizontal direction such that the viewed line moves from one side of the monitored region to the other side in a time period of typically 0.1 to 0.3 seconds. During a single image acquisition cycle, this results in the electronic signal being composed of a series of line measurements, typically 2048 to 16384. At the completion of each image acquisition cycle, the at least a first sensor device 50 resets itself and begins a subsequent image acquisition cycle, such that the electronic signal consists of a continuous sequence of images. The analog video signal is converted into a digital video signal by sampling the analog signal at periodic intervals and producing a digital (i.e., binary encoded) number representing the voltage amplitude at the sampling instant.

With continued reference now to FIG. 2, the captured image data comprises a digital representation of a sequence of images which may be temporally displayed on a display device. Typically, the captured image data comprises a plurality of frames wherein each frame represents a separate image. The frames may be further subdivided such that the frames are made up of a series of pixels. As used herein the term “pixel” means a single point of an image. The greater the number of pixels that are contained in an image, the greater the resolution of the captured image data. Resolutions are conventionally referenced by length and width measurements of the number of pixels. For example, in a resolution of 800×600, there are 800 pixels along the width of an image by 600 pixels along the height of the image. In one embodiment, the captured image data comprises a digital representation of a sequence of images of a monitored area 51.

With reference now to FIGS. 1, 22, the at least a first sensor device 50 transmits the captured image data to the decisive interface box system 10. The at least a first sensor device 50 may transmit the captured image data utilizing any conventional format such as MPEG-2, MPEG-4. The captured image data is received by the decisive interface box system 10 (step S04) and then stored, at least temporarily (step S05). An initial processing of the captured image data is subsequently performed wherein any compressed captured image data received from the first sensor device 50 is decompressed (step S06). In another embodiment, the at least a first sensor 50 transmit the captured image data in an analog format and the step of decompressing the captured image data is replaced with the step of converting the analog data into digital data.

With reference now to FIGS. 1, 3A, 3B, 22, and 23, in one embodiment, the captured image data processed by performing signal processing on the captured image data to remove and prevent noise from the input image frames (step S08). The processed captured image data is then stabilized (step S09) to eliminate motion induced flicker in the displayed image. In one embodiment, the processed captured image data is stabilized by determining a plurality of motion vectors 61 caused by unintended movement of the at least a first sensor 50, vice the motion of a moving image, within a particular frame of the captured image data. The plurality of motion vectors 60 on a first frame that correspond to the motion of a moving image are directed to various directions corresponding to motions of individual macroblocks 62 (as shown in FIG. 3A). However, the plurality of motion vectors 61 on the first frame that correspond to the motion of the at least a first sensor 50 are directed to the substantially same direction (as shown in FIG. 3B). Therefore, when the rate of motion vectors which are directed to the substantially same direction is higher than a predetermined rate, it can be determined that unintentional or inadvertent movement of the at least a first sensor 50 has occurred. Upon determining that the rate of motion vectors that are directed to the substantially same direction is higher than the predetermined rate, motion compensation for all pixels of the individual macroblocks 62 is performed by amounts corresponding to the determined motion vectors 61.

With reference now to FIGS. 2, 3A, 3B, 22, in one embodiment, a motion vector 60 (corresponding to the motion of a moving image) of a macroblock 62 is calculated to at least partially determine a feedback control data (step S10). The motion vector 60 is determined by comparing corresponding macroblocks within successive frames. The motion vector 60 indicates a direction of a tracked image 51a moving among the captured image data of the preceding and following frames. The motion vector 60 is calculated based on differences between the captured image data of the macroblock 62 of a first image frame N and the captured image data of the macroblock 62 of at least a first preceding image frame (not shown) of the captured image data. In one embodiment, the motion vector 60 is represented in two dimensions, i.e., in the horizontal and vertical directions. For example, if the motion vector of a particular macro block shows the values (2,−3), it means the motion vector of the particular macro block has moved by two pixels in the horizontal direction, and by −3 pixels in the vertical direction. In one embodiment, the captured image data is divided into a plurality of image zones (step S10a). Each of the individual image zones is then categorized as either comprising a portion of a background region or a motion region (step S10b). The categorization of the plurality of image zones causes the tracked image to be extracted into the motion region. The motion region is then analyzed to determine the size and motion information of the tracked image 51a (step S10c) thereby resulting in the determination of the motion vector 60 (step S10d).

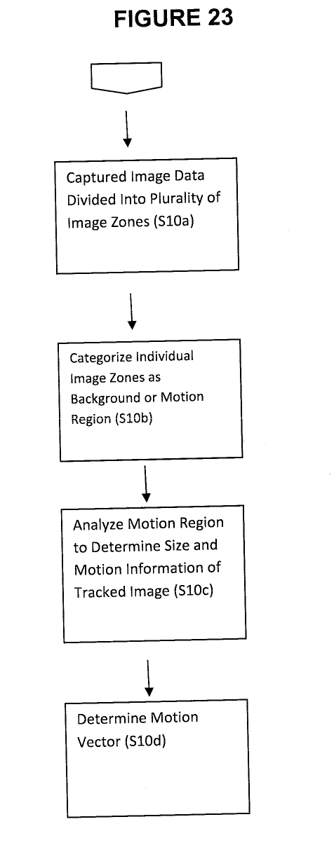

With reference now to FIGS. 2 and 23, in one embodiment, the motion vector 60 is utilized to determine a feedback control data (step S15). The feedback control data is then transmitted to the at least a first sensor device 50 (step S16). The at least a first sensor device 50 receives the feedback control data and the feedback control data at least partially causes the adjustment of the at least a first sensor device 50 wherein the tracked image is “tracked” or maintained substantially centered within the individual frames of the successive frames comprising the captured image data. In one embodiment, a microprocessor 57 controls a driving unit 56 to cause the adjustment of the at least a first sensor 50. In one embodiment, the driving unit 56 includes a lens driving unit 56a for adjusting the lens for pan/tilt and zoom-in/zoom-out with respect to the input tracked image, and a first sensor device driving unit 56b for shifting the direction of the first sensor device 50 and to track and photograph the tracked image.

With reference now to FIG. 22, the stabilized captured image data is then averaged (step S17) wherein, generally, the values of adjacent pixels in the stabilized captured image data are added to one another and the result is appropriately divided to create an approximation of the pixel number thereby reducing the number of unique pixel numbers in a localized area of the individual image frame. Each of the individual image frames comprising the captured image data comprise a plurality of pixels ordered in rows and columns as described above. The bit size of an individual pixel comprising the plurality of pixels comprising the individual image frame varies depending upon the information intended to be represented by that pixel. Commonly, pixels comprise three different bit sizes, 8-bit, 16-bit, and 24-bit. Typically, 8-bit pixels are utilized to represent a monochrome display of an image, while 16-bit and 24-bit pixels are utilized to represent a color display of an image. The specific averaging process employed may vary depending on the bit size (e.g., 8-bit, 16-bit, or 24-bit) used to represent a pixel, whether the pixel represents color attributes, the relative priority between speed of calculation versus quality of image, and the amount of available information with respect to adjacent pixels.

With reference now to FIG. 22, the stabilized, averaged captured image data is then compressed (step S18) thereby resulting in the stabilized captured image data being represented with less data. By being able to represent the stabilized, averaged, compressed captured image data utilizing less data relative to the original captured image data the speed and efficiency with which the captured image data may be transmitted across a network can be increased. Additionally, the compression of the stabilized, averaged, compressed captured image data results in a reduction in the amount of storage necessary for storing the stabilized, averaged, compressed captured data and the amount of bandwidth necessary for the transmitting the stabilized, averaged, compressed captured data across the network. In one embodiment, a lossless compression process is utilized wherein the subsequent decompression of the captured image data results in a bit-for-bit match with the original captured image data. In another embodiment, a lossy compression process is utilized wherein the subsequent decompression of the captured image data results in a reconstructed version of the captured image data.

With continued reference now to FIG. 22, in one embodiment, the stabilized, averaged captured image data is compressed utilizing both intra-frame compression and inter-frame compression. The adjacent or neighboring pixels comprising an individual image frame frequently comprise similar or identical values or pixel numbers. Intra-frame compression utilizes the high correlation between the adjacent or neighboring pixels within an individual image frame to remove redundant pixel data or information. In addition to compressing the stabilized, averaged captured image data utilizing correlated data occurring within an individual frame, the stabilized, averaged captured image data is also compressed utilizing correlated data relating to the same pixels occurring in successive image frames or inter-frame compression. Commonly, only a relatively small fraction of the stabilized, averaged captured image data changes between successive image frames. This means that each pixel in the first image frame N is highly correlated with the corresponding pixel in the subsequent image frame N+1. Generally, an algorithm, such as a discrete cosine transform (DCT), is utilized that allows for the removal and subsequent reconstruction of redundant pixel data or information. The algorithm utilizes retained pixel data or information to allow for the subsequent reconstruction of the removed pixel data or information. The use of the algorithm combined with the high correlation between adjacent or neighboring pixels and corresponding pixels in successive image frames enables the stabilized, averaged, compressed captured image data to be represented utilizing relatively fewer bytes of data.

With reference now to FIGS. 1 and 22, the stabilized, averaged, compressed captured image data is then transmitted across the network (step S19). In one embodiment, the decisive interface box system 10 comprises a transmission component 300 that interfaces the decisive interface box system 10 with the network 90. The transmission component 300 comprises a digital signal processor 301, an antenna 302, a radio frequency (RF) amplifier 303, and a RF adapter 304. The digital signal processor 301 performs the required signal-manipulation calculations for transmitting and receiving data across the network. The antenna 302 promulgates and receives the data from the network. The RF amplifier 303 amplifies signals traveling to and from the antenna 302. The RF adapter 304 interfaces and manages the plurality of FM channels that may comprise the network. Additionally, the decisive interface box system 10 may receive data from the associated network 90 via the transmission component 300. In one embodiment, the decisive interface box system 10 may receive software and hardware updates that are then processed and installed thereby allowing for the remote updating of the decisive interface box system 10.

With reference now to FIG. 1, in one embodiment, the decisive interface box system 10 is in a device form. The decisive interface box system 10 includes a sensor interface module 501, a stabilization module 502, and an averaging and compression module 503. The sensor interface module 501 receives the captured image data from the at least a first sensor device 50. The sensor interface module 501 passes the captured image data to an image input module 505. The image input module 505 stores the captured image data, at least temporarily, to a memory module 506. A pre-processing module 507 decompresses any compressed captured image data. In another embodiment, the captured image data is received by the sensor interface module 501 as an analog signal and the pre-processing module 507 subsequently transforms the analog signal into digital data using a conventional analog-to-digital conversion process.

With reference now to FIGS. 1 and 2, in one embodiment, the image stabilization module 502 receives the pre-processed capture image data and removes unwanted noise and stabilizes the captured image data to eliminate motion induced flicker as described above. The image stabilization module 502 also determines the feedback control data and passes the feedback control data to the sensor interface module 501. The sensor interface module 501 causes the feedback control data to be transmitted to the at least a first sensor device 50 to allow for the tracking of a tracked image 51a as described above. The stabilized captured image data is passed to an averaging and compression module 503 wherein the stabilized captured image data is averaged and compressed. The averaging and compression module 503 passes the stabilized, averaged, compressed captured image data to a transmission module 300. The transmission module 300 causes the stabilized, averaged, compressed captured image data to be transmitted across the network. In one embodiment, the stabilized, averaged, compressed captured image data is transmitted across the network and received by a command and control module 550 where the stabilized, averaged, compressed captured image data is viewed, analyzed and recorded. The command and control module 550 may comprise a second decisive interface box system 10′. In one embodiment, the second decisive interface box system 10′ may be in communication with a plurality of decisive interface box system 10 interfaced with a plurality of sensor devices. The second decisive interface box system 10′ provides a central command location that allows for the central collection and analysis of sensor device data collected from various remote and widespread areas.

With reference now to FIG. 1, in one embodiment, the second decisive interface box system 10′ interfaces with the display device 2 and a global positioning system (not shown). A topographical map is inputted and displayed on the display device 2. The topographical map, global positioning system, and the data received from across the network from the at least a first decisive interface box system 10 allow the second decisive interface box system 10′ to display the relative locations of the plurality of sensor devices 50 on the display device 2.

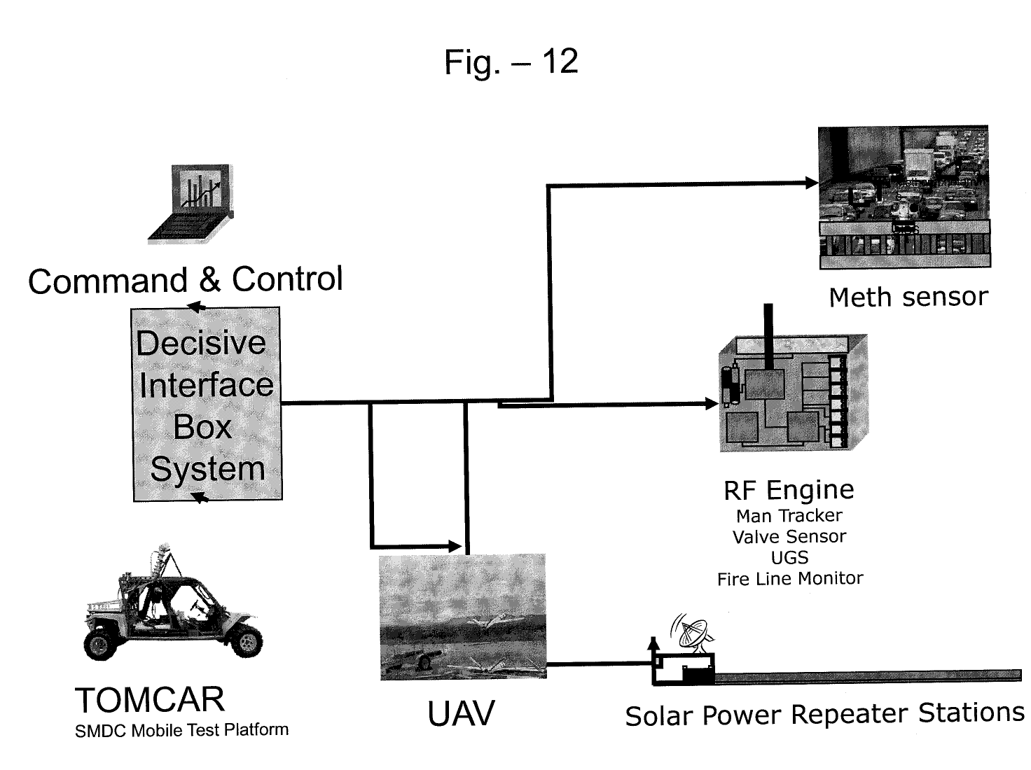

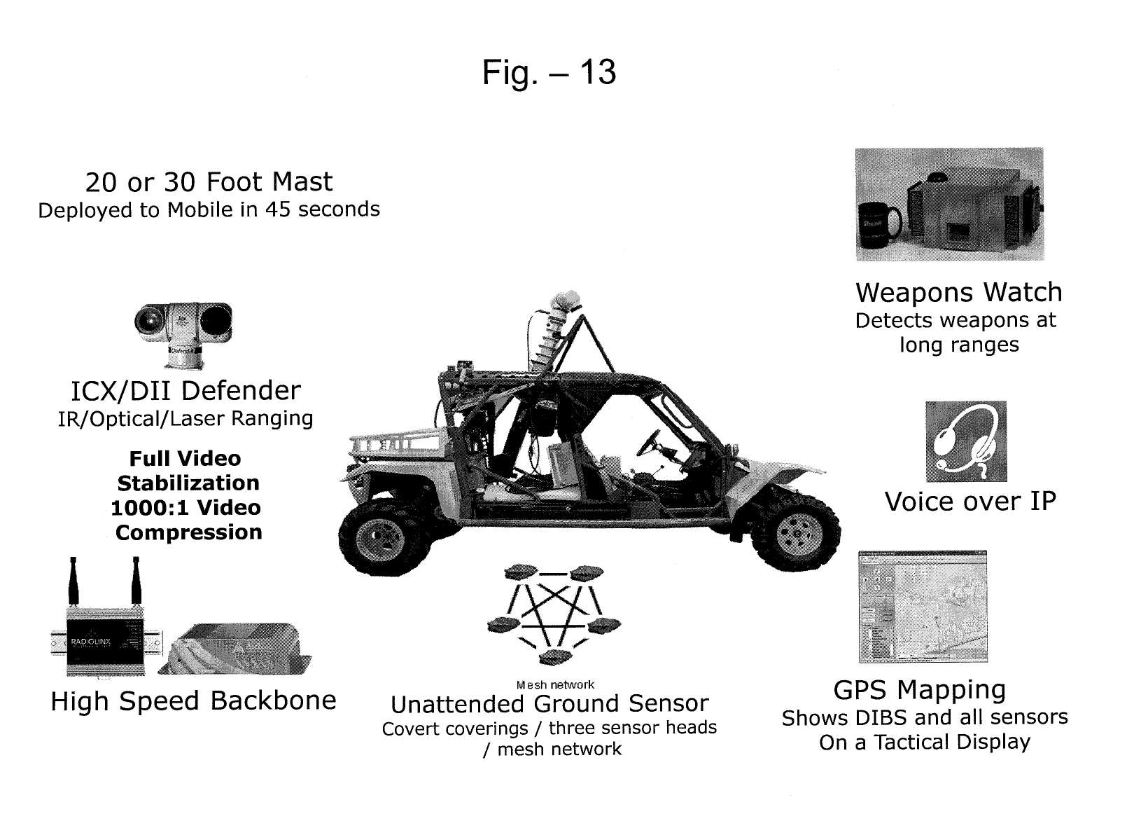

With reference now to FIGS. 12 and 13, in one embodiment, the decisive interface box system 10 is mounted on a vehicle 20 and interfaces with the first sensor 50. The first sensor 50 is coupled to a telescopic mast 22 that is mounted on the vehicle 10. The first sensor 50 may be controlled via the input device portion 3. In one embodiment, the first sensor 50 comprises the image capture device described above. In another embodiment, the first sensor 50 comprises a radar or target acquisition device 50a. The target acquisition device 50a transmits data to the decisive interface box system 10 regarding the direction, distance, and elevation of a target relative to the current location of the vehicle 20. In one embodiment, the decisive interface box system 10 mounted on a vehicle 20 interfaced with a target acquisition device 50a may be used in conjunction with a second decisive interface box system 10 mounted on a second vehicle 20 interfaced with a second target acquisition device 50a. The second decisive interface box system 10′ is in electrical communication with the first decisive interface box system 10 allowing for the passing and sharing of data regarding a particular target. For example, the first decisive interface box system 10 may be positioned at a first location and the second decisive interface box system 10′ may be positioned at a second location. Both the first decisive interface box system 10 and the second decisive interface box system 10′ detect the firing of a small caliber projectile. The first decisive interface box system 10 and the second decisive interface box system 10′ may transmit to the other information relating to the firing of the small caliber projectile and each may use triangulation techniques to determine the precise location of the shooter relative to the respective vehicle 20.

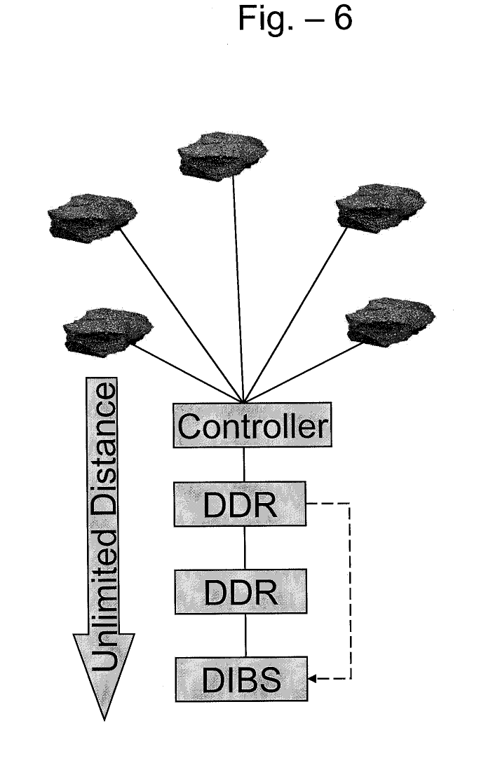

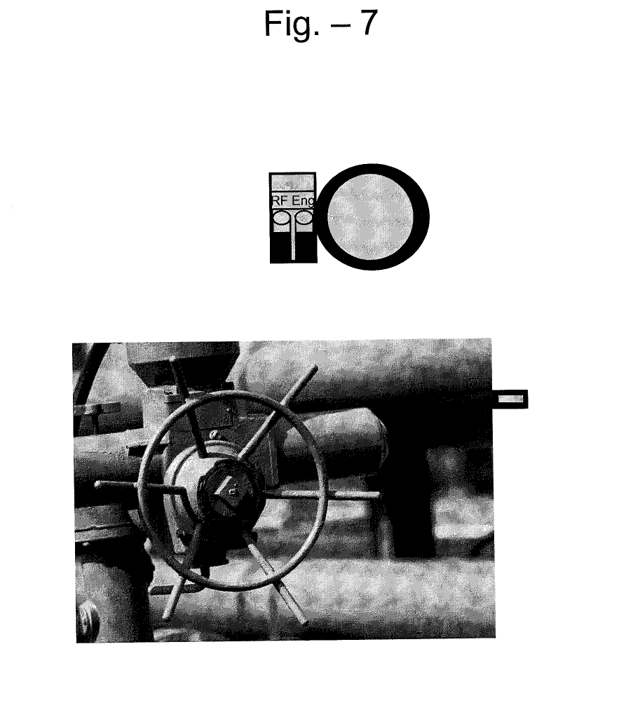

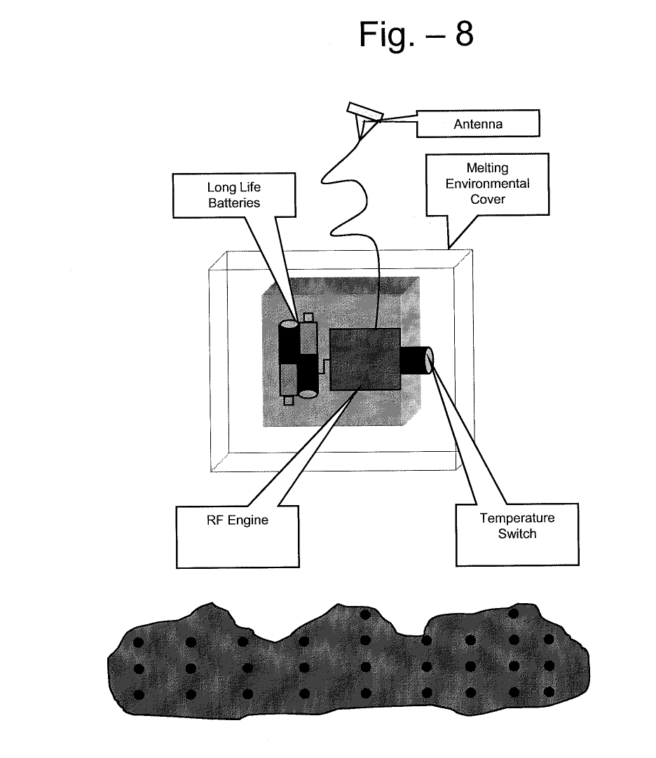

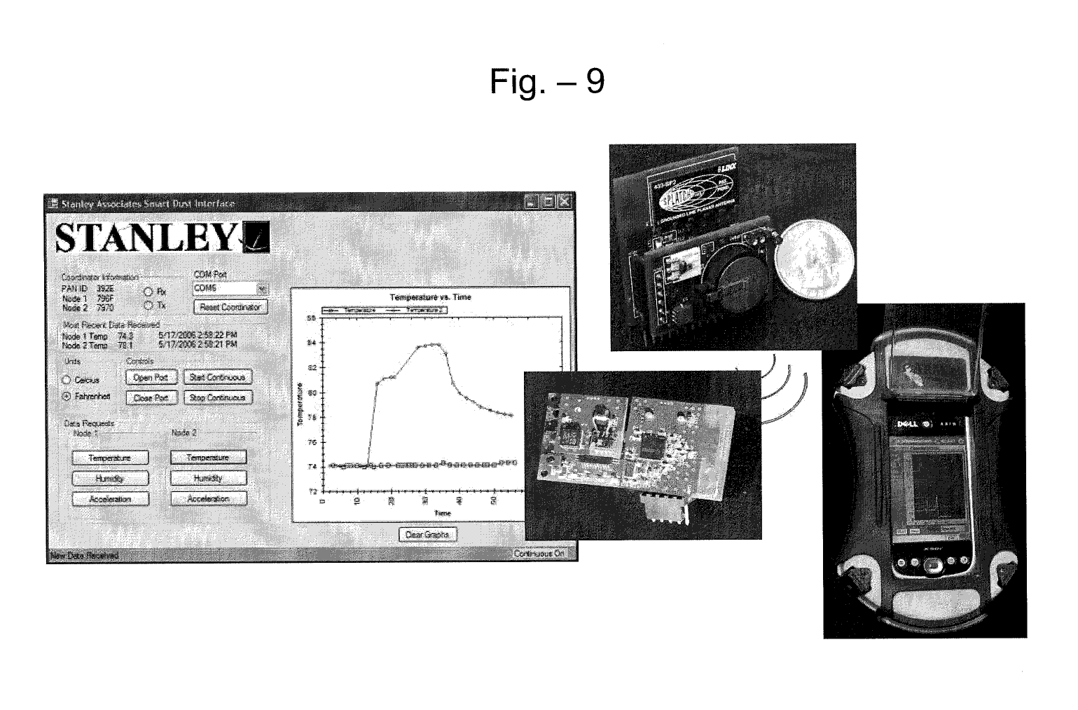

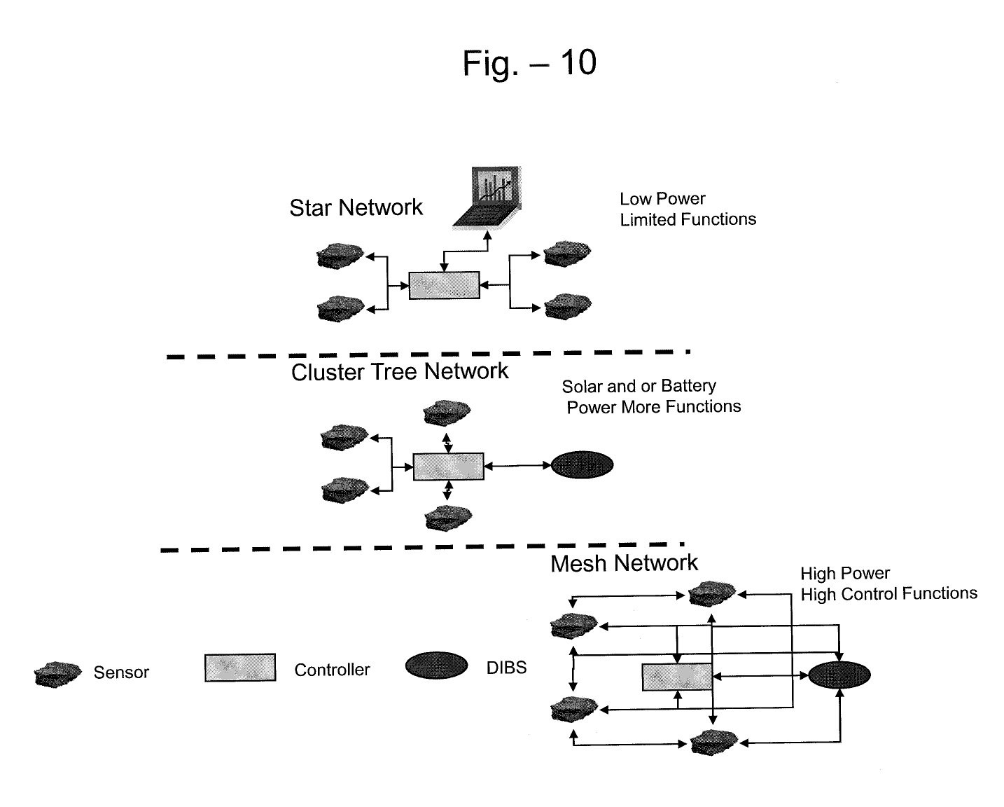

With reference now to FIGS. 6-10, in one embodiment, the decisive interface box system 10 interfaces with the at least a first sensor 50 wherein the at least a first sensor 50 comprises at least a first unattended ground sensor 50. The at least a first unattended ground sensor 50 may comprise a plurality of sensor heads and covert coverings. In one embodiment, the at least a first unattended ground sensor 50 may comprise a first sensor head for sensing audio, a second sensor head for sensing video, and a third sensor head for sensing temperature. Additionally, the at least a first unattended ground sensor 50 may comprise a portion of a mesh network of sensors. Other embodiments include remote valve monitoring and fire line monitors. In this embodiment, the wireless sensor nodes are configurable to provide any combination of temperature, humidity, acceleration data with options for chem/bio detection, and are interfaced over RS-232 to a GUI, with an option for a USB interface. And in this embodiment, the RF engine contains a microcontroller, a RF Engine, the SNAP network software and amplifiers. This allows the user to match sensors to forward deployed sensors at a very low cost using one of the three network schemes and the interface box system as the communication and GPS backbone.

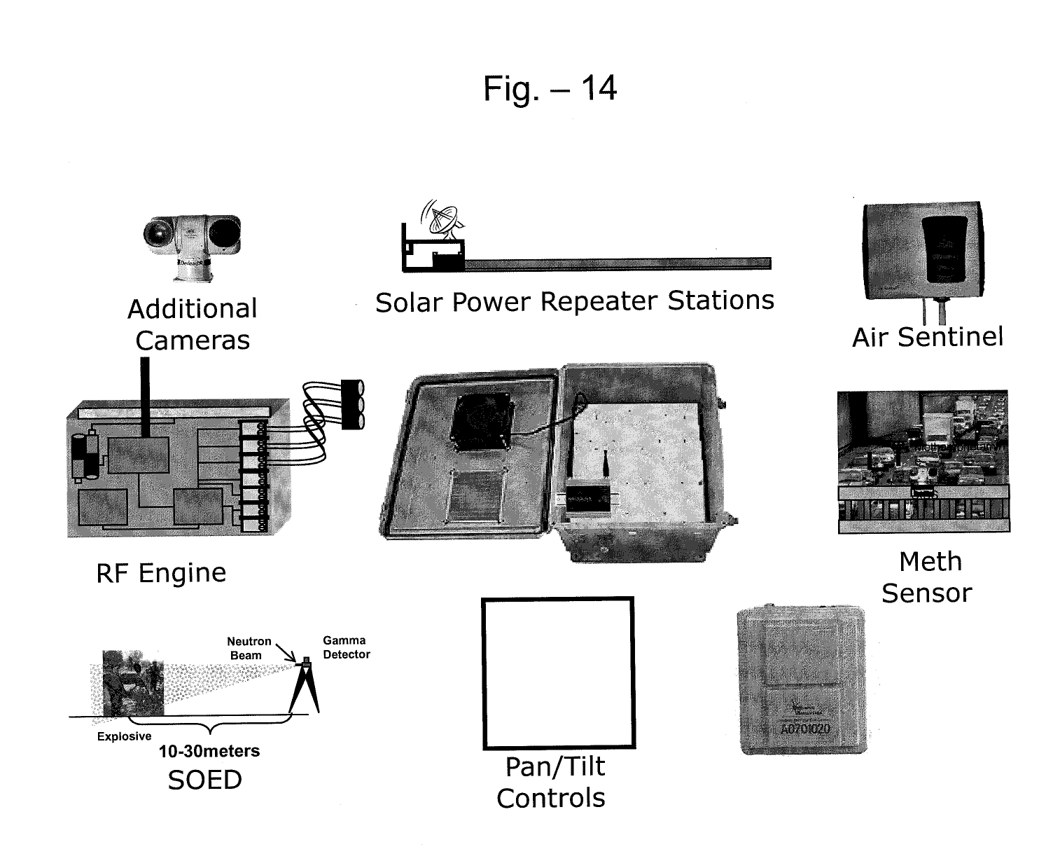

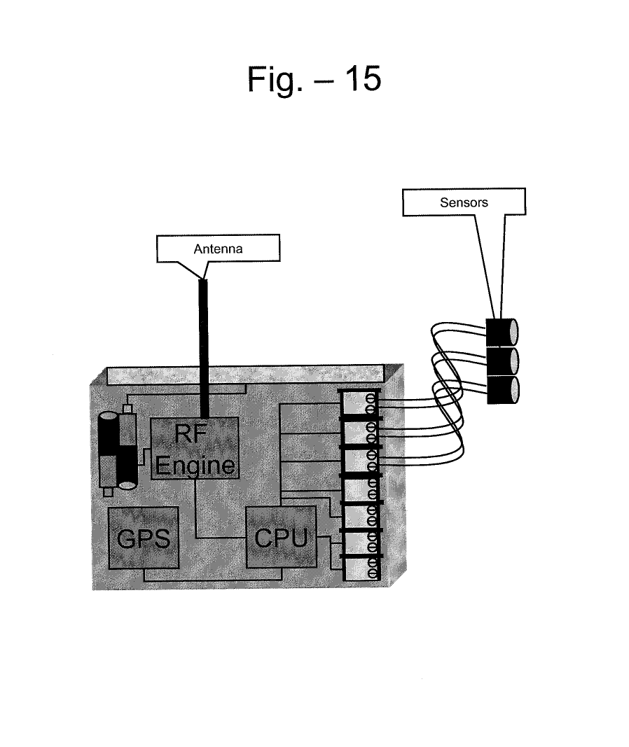

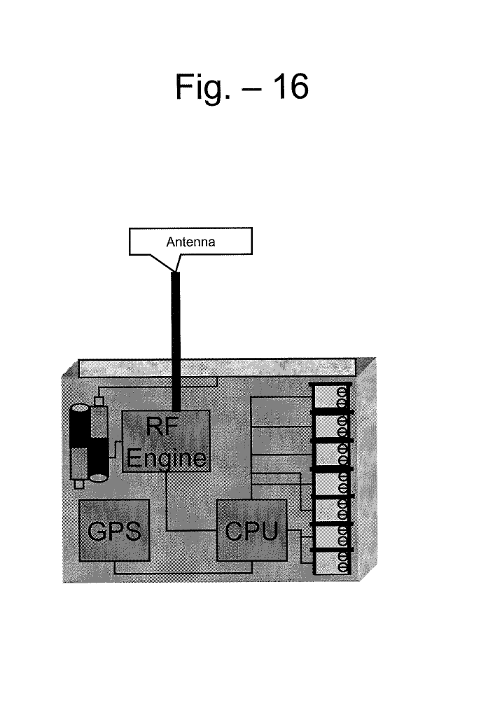

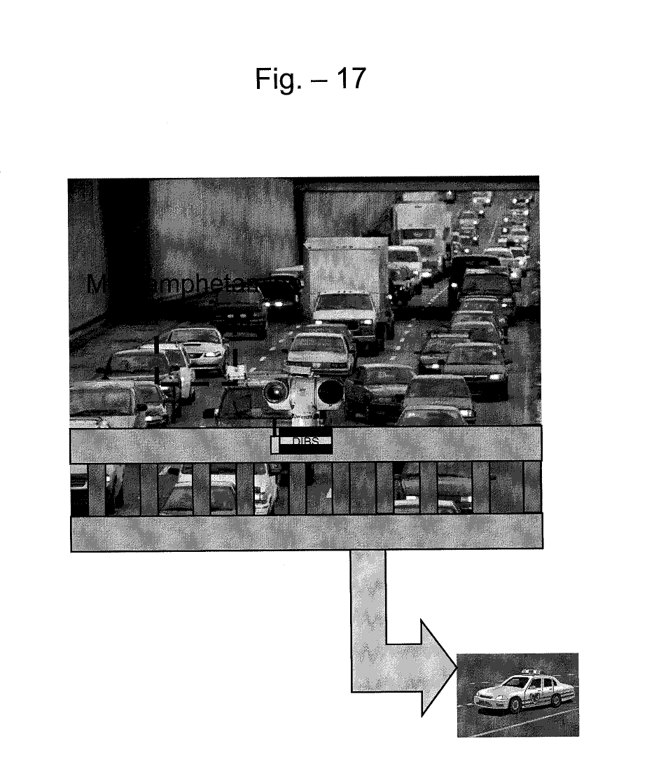

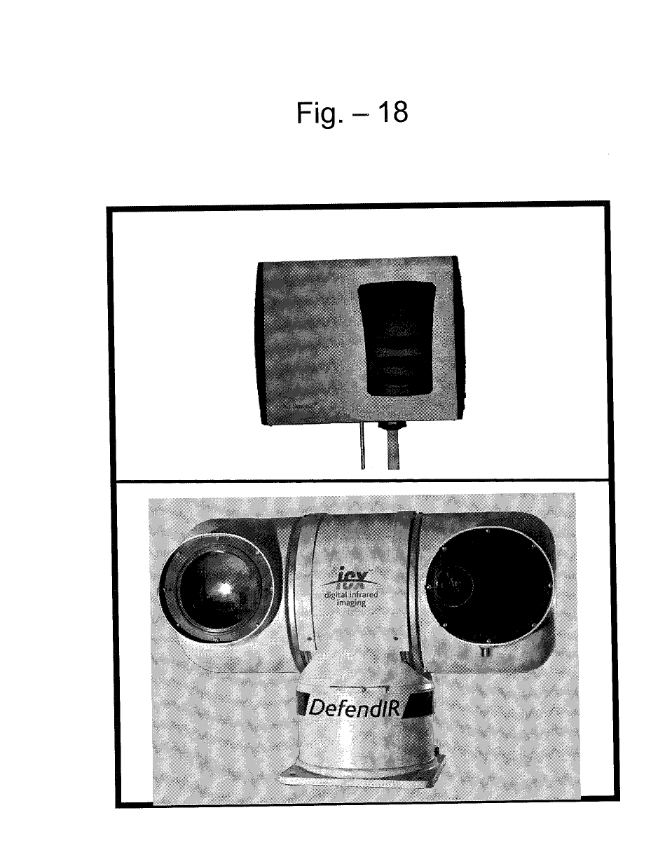

With reference now to FIGS. 14-19, in one embodiment, the decisive interface box system 10 interfaces with a plurality of sensors 50 positioned to monitor individual vehicles traveling on a specific roadway. The each of the plurality of sensors 50 comprises a micro ultraviolet spectrometer capable of detecting the existence of methamphetamine, alcohol, and cocaine in passing vehicles. One embodiment uses a mobile micro UV spectrometer which can detect methamphetamine, alcohol, and/or cocaine. In another embodiment a cluster tree network of unattended ground sensors can detect seismic activity or act as a magnetometer. In another embodiment, environmental sensors can detect temperature, humidity, vibration, pressure, chemicals, such as chlorine, CO², and LPG, natural gas, alcohol, and carbon monoxide. In this embodiment, a remote antenna can be used for a longer range. There is also a solar power option and analog/digital connectors. The management software for each integrated sensor allows the sensors to be interchanged with other sensors in the field. In another embodiment (see FIG. 17), the system 10 is designed for first sweep responders after a natural disaster, and allows the first sweep responders to tag walking wounded, people who need to be stabilized, and deceased individuals. The system 10 can be used to track tags in a natural disaster.

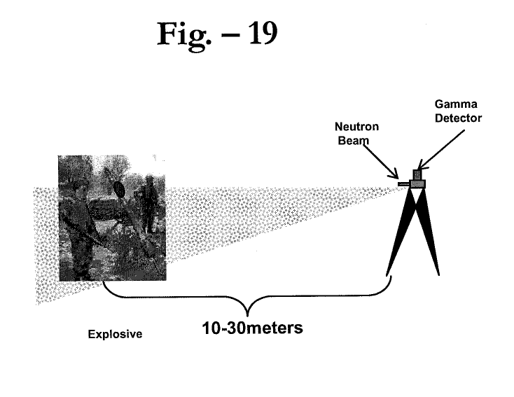

With reference now to FIG. 19, a stand off explosion detection system is shown. A neutron beam illuminator system, which is ground mounted on a moving vehicle for explosives detection. The neutron irradiation of target will result in gamma rays which will be detected by a gamma ray detector mounted on the same system. The entire mounted system weighs around 15-25 lb with the neutron illuminator weighing 10 lb and gamma ray detector weighing <5 lbs. The processor component (PC) is contained in the interface box system. Processing times for explosive detection up to 30 meters away will be no more than 1.5 seconds. This detection system is designed to perform explosive detection in vehicles with speeds as high as 30 mph. This system can be used for remote detection of explosives located several meters away from moving vehicles with speeds up to 30-40 mph in times of the order off 1.5 seconds or less. The design will be such that operational capability of 20-30 meter range for Explosive detection is feasible. This will provide capability of stand off explosive detection that does not currently exist. The system being proposed for design and build can also be used on ships, border crossings, aircraft, UAVs and UN mine clearing program. Portable hand held version can be used for detection of explosives on suicide bombers.

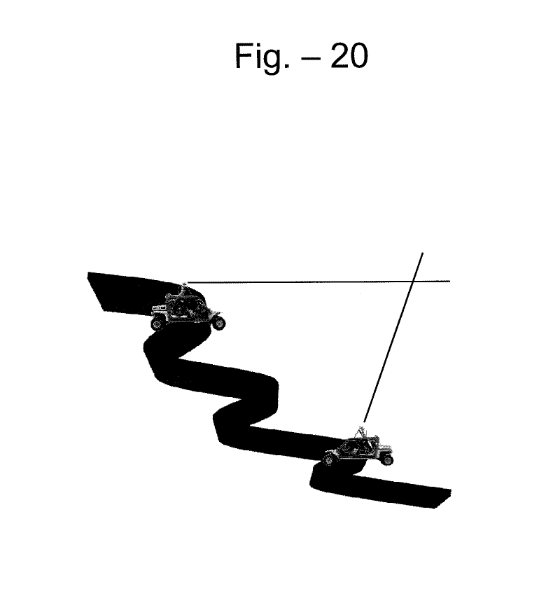

With reference now to FIG. 20, a weapon watch system is shown. The system provides a highly reliable, wide area surveillance capability for the real-time detection, classification, and location of direct and indirect hostile weapon fire with a very high probability of detection and a very low false alarm rate. The system can detect and classify small arms, RPGs, mortars, MANPADS (man-portable air-defense systems), tanks and artillery beyond the effective range of the threat weapon and can process more than one thousand weapons fire events per second. The system can display threat type and location, cue imaging systems and weapons, and support a common operating picture in real-time using existing tactical communications system, radios, and architectures, operate standalone or within existing command, control, communications, computers and intelligence (C4I) architectures, and provides a wide field-of-view (FOV) that is field selectable. Optional imager modules can be added for enhanced imaging and laser ranging.

The decisive interface box system connects to sensors in one of three ways: first, hardwire or running either copper cable or fiber optic cable from the sensor to the system; the second connection is a 2.4 GHz Radio Frequency engine (transmitter/receiver) which has a theoretical range of three miles and enough bandwidth to carry data from digital and analog sensor; finally the sensors can have a 900 MHz Radio Frequency engine with a theoretical range up to 40 miles with good line of site and match antennas. The amount of bandwidth required for video prevents the use of RF engines as a reliable video communications device. Digital and analog sensors, which are smaller and can be used in the field under different conditions than video, require far less bandwidth and thus can be used in conjunction with either the 2.4 GHz or 900 MHz RF engines as the communications backbone. The present invention is unique in how these different RF engines interface with our system, because of the software written to interface between the different types of sensors and the communications backbone. The user can take the outputs from any sensor being used (Fire line, Unattended Ground Sensor, Man Tracker, Radiation, Chemical Biological and any of the hundreds of environmental sensor heads) and collect the sensor head output, reformat these sensor head outputs into something that can be transmitted by an RF engine. Once the sensor data has been sent through the RF engine backbone system then sensor head data is converted again in to a format that can be read and displayed by the interface box system. This data in turn is display on the vehicle where the interface box system is located and then sent via the communications backbone (Radio/Cell Phone/Satellite) to a Command & Control Center using a standard XML format.

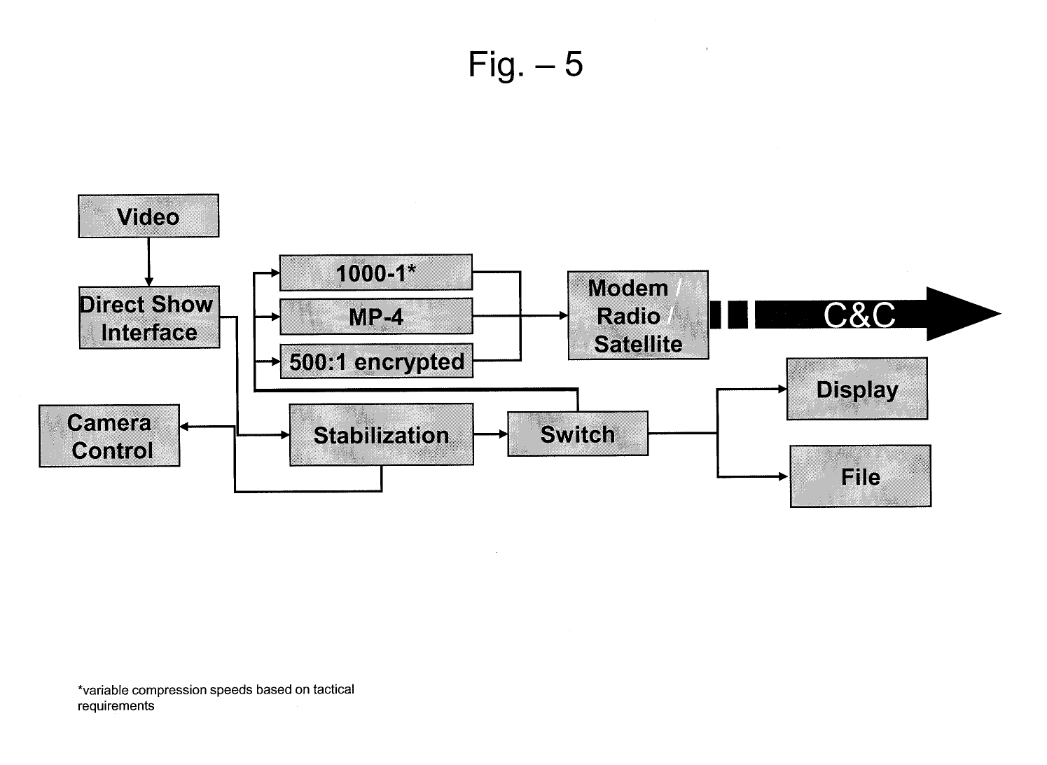

With reference now to FIG. 5, a flow chart of compression and stabilization is shown. The stabilization removes vibration from a streamed video image making the file smaller, and the invention can track a target once the system is locked. Once the video stream is stabilized, the decisive interface box system 10 will compress the image using a high speed frame to frame comparator. In one embodiment, the video can be compressed at a rate of 1000:1. Compression speeds can vary based on tactical requirements. This allows the system 10 to stream real time video on a cell phone modem on one channel and still support four other sensors working at the same time.

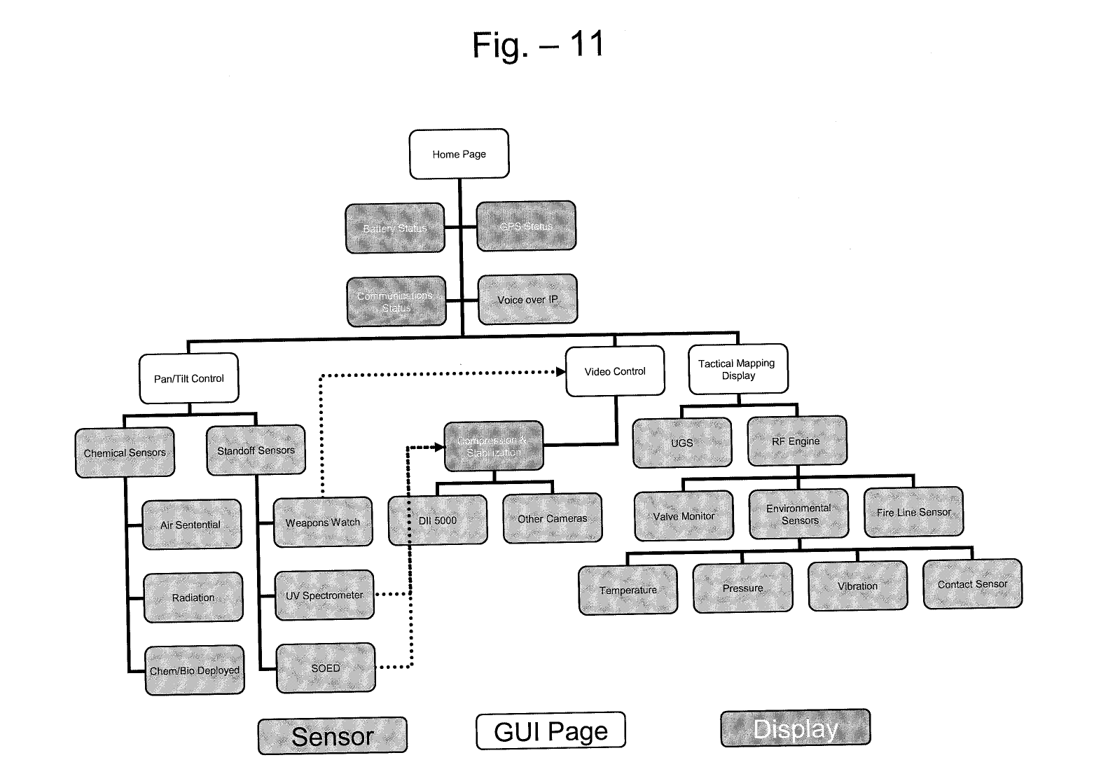

With reference now to FIG. 11, a diagram showing display logic is shown. The diagram shows the operation of the system 10 in various embodiment within the invention.

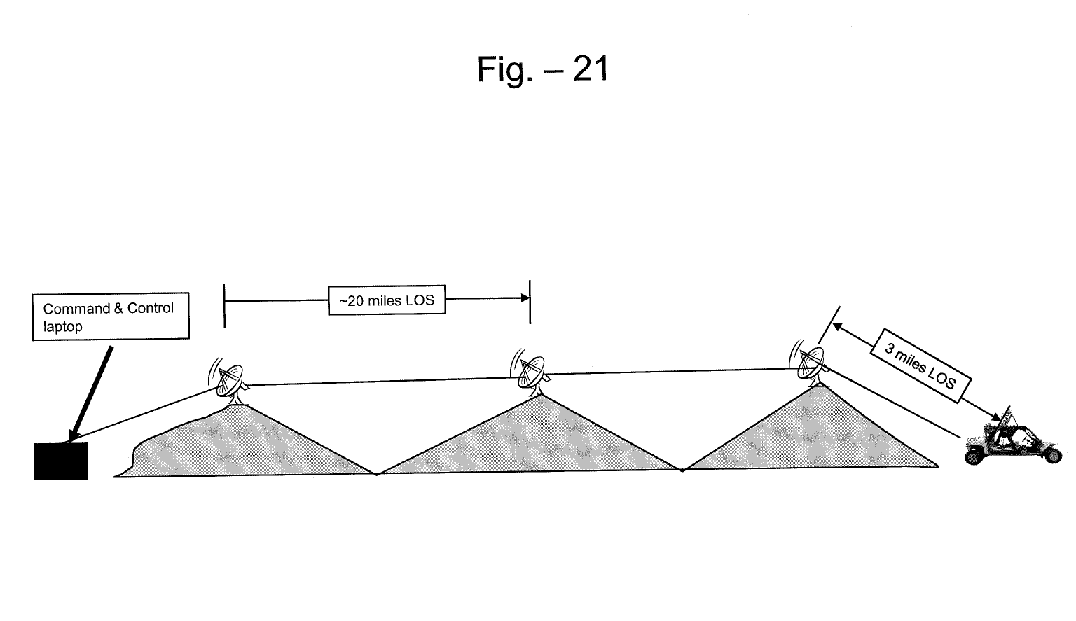

With reference now to FIG. 21, a weapon surveillance embodiment is shown. This embodiment provides a reliable, wide area surveillance capability for real-time detection, classification, and location of direct and indirect hostile weapon fire with a high probability of detection and a low false alarm rate. This embodiment can detect and classify small arms, RPGs, mortars, MANPADS, tanks, and artillery beyond the effective range of the threat weapon and can process more than one thousand weapons fire events per second. This embodiment can display threat type and location, cue imaging systems and weapons, and support a common operating picture in real-time using existing tactical communications system, radios, and architectures. This embodiment can operate stand-alone or within existing command, control, communications, computers, and intelligence (C4I) architectures. This embodiment provides a wide field-of-view (FOV) that is field selectable. Optional imager modules can be added for enhanced imaging and laser ranging.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. An apparatus comprising:
at least a first interface system comprising:
a sensor interface portion for receiving an input of successive frames of a moving image from a video capture device;
a processor portion that causes the input of successive frames of the moving image to be stabilized, compressed, and averaged,
wherein the stabilization of the successive frames of the moving image reduces the effects of unintended motion of the video capture device and is utilized to determine a feedback control,
wherein the processor portion utilizes the feedback control to cause the moving image to remain substantially centered within the individual frames of the input of successive frames of the moving image by causing the adjustment of the video capture device; and,
a transmission component portion for transmitting the stabilized, compressed, and averaged input of successive frames of a moving image across a network.

2. The apparatus of claim 1, further comprising:
a hardened exterior shell encasing the at least a first interface system.

3. The apparatus of claim 2, wherein the hardened exterior shell is mounted on a vehicle.

4. The apparatus of claim 2, wherein the interface system is shock-mounted within the hardened exterior shell.

5. The apparatus of claim 1, wherein the at least a first sensor interface portion further comprises:
a sensor interface channel for communicating with an external device.

6. The apparatus of claim 1, wherein the at least a first sensor interface portion further comprises:
a plurality of sensor interface channels for communicating with a plurality of external devices.

7. The apparatus of claim 1 further comprising:
a repeater apparatus, wherein the repeater apparatus receives the stabilized, compressed, and averaged input of successive frames of the moving image transmitted by the transmission component and re-transmits the stabilized, compressed, and averaged input of the successive frames of the moving image to a control center apparatus capable of receiving the stabilized, compressed, and averaged input of successive frames of the moving image.

8. The apparatus of claim 1, further comprising:
a first repeater apparatus and a second repeater apparatus, wherein the first repeater apparatus receives the stabilized, compressed, and averaged input of successive frames of the moving image transmitted by the transmission portion and re-transmits the stabilized, compressed, and averaged input of successive frames of the moving image to the second repeater apparatus,
wherein the second repeater apparatus receives the stabilized, compressed, and averaged input of successive frames of the moving image from the first repeater apparatus and re-transmits the stabilized, compressed, and averaged input of successive frames of the moving image to a control center apparatus.

9. An apparatus comprising:
a data capture portion comprising:
at least a first sensor;
at least a first interface system for transmitting data received by the data capture portion across a communications network, wherein the at least a first interface system is in communication with the data capture portion and comprises:
a hardened exterior shell;
a sensor interface portion;
a power supply portion
a control unit comprising a microprocessor,
wherein a first data stream of successive frames of a moving image that is transmitted by the at least a first sensor and received by the sensor interface portion is stabilized to reduce the effects of unintended motion of the at least a first sensor,
wherein the control unit analyzes the stabilized first data stream of successive frames of the moving image and causes the adjustment of the at least a first sensor
wherein the adjustment of the at least a first sensor causes the moving image to remain substantially centered within the successive frames of the moving image;
wherein the stabilized first data stream of successive frames of the moving image is then compressed and averaged;
a transmission portion for transmitting the stabilized, compressed, and averaged first data stream of successive frames of the moving image across a network.

10. The apparatus of claim 9 further comprising:
a telescoping mast portion, wherein the sensor interface portion is coupled to the telescoping mast portion.

11. The apparatus of claim 9, wherein the at least a first sensor is chosen from the group consisting of: an image capture device, a micro ultraviolet spectrometer, an unattended seismic ground sensor, a magnetometer, a remote valve monitoring sensor, a fire line monitoring sensor, and an environmental sensor.

12. The apparatus of claim 9, wherein the data capture portion further comprises:
a plurality of sensor devices.

13. The apparatus of claim 9 further comprising:
a second data capture portion and a second interface system for transmitting data received by the second data capture portion across the communications network, wherein the second interface system is in communication with the at least a first interface system.

14. A computer-readable medium having a set of instructions to cause a computer to perform the following operations:
(a) receiving an input of successive frames of a moving image from a first sensor device;
(b) stabilizing the input of successive frames of the moving image to reduce the effects of unintended movement of the first sensor device and to determine a feedback control data;
(c) adjusting the position of the first sensor device to cause the moving image to remain substantially centered within the input of successive frames of the moving image, wherein the adjustment of the first sensor device is based at least partially on the feedback control data;
(e) compressing and averaging the stabilized input of successive frames of the moving image;
(f) transmitting the averaged, compressed, and stabilized input successive frames of the moving image across a communication network.

15. The computer-readable medium of claim 14, wherein step (f) further comprises the step of:
transmitting the averaged, compressed, and stabilized input of successive frames of the moving image across a communication network to a repeater apparatus.

16. The computer-readable medium of claim 15, further comprising the step of:
re-transmitting the averaged, compressed, and stabilized input of video image data to a control center apparatus.
